(19) United States
(12) Patent Application Publication
(10) Pub. No.: US 2026/0306985 A1
(43) Pub. Date: Oct. 8, 2026

(54) EMBEDDED PLEAT FACE STABILIZING STRUCTURE FOR DEEP PLEATED EMBOSSED HEAVY DUTY PANEL AIR MEDIA PACKS AND/OR END CAP CATCH FEATURE

(71) Applicant: Baldwin Filters, Inc., Cleveland, OH (US)

(72) Inventors: Charles R. Wick, Pleasanton, NE (US); Simon D. Ritchie, Kearney, NE (US); Farrell Calcaterra, Kearney, NE (US); Joshua W. Witte, Kearney, NE (US); Levi W. Dexter, Elm Creek, NE (US)

(73) Assignee: Baldwin Filters, Inc., Cleveland, OH (US)

(21) Appl. No.: 19/683,047

(22) Filed: May 20, 2026

Related U.S. Application Data
(63) Continuation of application No. PCT/US2024/059529, filed on Dec. 11, 2024.
(60) Provisional application No. 63/610,010, filed on Dec. 14, 2023.
(60) Provisional application No. 63/718,045, filed on Nov. 8, 2024.

(51) Int. Cl. B01D 46/52

(52) U.S. Cl. CPC B01D 46/523; B01D 2265/04; B01D 2265/06

(57) ABSTRACT

A filter element is provided with a reinforcing structure that is embedded in a flow face of a filter media pack that may be provided by pleated filter media defining pleat tips. Another reinforcing structure can also be embedded into the other flow face such that both inlet and outlet faces are even further stabilized. The reinforcing structure can include a thermoplastic material and provided as a preform that is at least partially melted to form an embedding melt pool to allow the reinforcing structure to be embedded into one of the flow faces of the filter media pack, such that the reinforcing structure can embedded into and mechanically entraps pleat tips.

### CROSS-REFERENCE TO RELATED PATENT APPLICATIONS

This Patent Application is a Continuation of PCT Patent Application No. PCT/US2024/059529, filed Dec. 11, 2024, which is now pending, the entire teachings and disclosure of which are incorporated herein by reference thereto. This Patent Application claims the benefit of U.S. Provisional Patent Application Nos. 63/610,010, filed Dec. 14, 2023, and 63/718,045 filed Nov. 8, 2024; the entire teachings and disclosure of each of which are incorporated herein by reference thereto.

### FIELD OF THE INVENTION

This invention generally relates to reinforcement structures for filter media packs and/or end cap catches for filter media packs.

### BACKGROUND OF THE INVENTION

The ability of the media pack of a pleated filter element to withstand operating pressures depends on various factors such as pleat count, pleat depth, and filter media's material property (stiffness). When a fluid flows through one face of a media pack, the pressure applied to that face can cause pleats to deform or collapse. A reinforcing structure is used in some situations to prevent deformation or collapse of the media.

One known example of such reinforcing structure are glue beads that can be applied to the face of the media through an automated dispensing mechanism. In this process, the glue beads are applied across a face of the media pack, and specifically, to the tips of the pleats, to provide lengthwise stabilization of the media pack, that is, in a direction across adjacent pleat tips. With the pleated tips reinforced to withstand pressure from flow-through fluid, deformation and collapse of the media pack can be prevented. U.S. Pat. Nos. 7,959,701 and 9,827,527 illustrate examples of such known glue beads. The use of glue beads, however, requires a large quantity of a melt bonding agent, resulting in increased cost and a negative environmental impact. Further the application of glue beads can have drips or unwanted application if not done carefully.

It is also known to provide resin in the media pleats for reinforcement and stabilization. Applying resin, however, can also increase the cost to manufacture the media pack and raise environmental issues.

Therefore, it is believed there is a need for a further automated method of manufacturing a reinforced pleated filter element, where the pleated filter element has good flow characteristics, structural stability, and strength; while having reduced cost and reduced environmental impact.

Additionally, it is also known to arrange frames such as seal support frames or otherwise upon a filter media pack as is shown and described in Published US. Patent Application US2024/0091691 to Krull entitled “Filter Cartridge Including U-Shaped Canted Inlet Frame; Filter System Including Same”; and U.S. Pat. No. 11,406,924 to Krull, entitled “Filter with protective/supportive flow face grating”. Each of these patent publications show filters with end caps and seal support structures, and also utilize grating (also referred to as flow face screens). As shown in Krull '924, small tabs may be provided in pre-formed end caps which tabs act as stops. The stop provides an abutment for the frame with gasket support as it is slid over media and opposing preformed end caps. These stops axially locate gasket support between inlet and outlet flow faces at a desired location. As will be appreciated by different inventive aspects, improvements over these designs are provided herein which can be employed in the embodiments of these Krull patent publications.

### BRIEF SUMMARY OF THE INVENTION

At least one embodiment provides a pleated filter media comprised of a folded panel with a plurality of pleat tips and valleys. The pleated filter media has an inlet face and an outlet face. A thermoplastic reinforcing webbing is applied across either the inlet face, the outlet face, or both the inlet and outlet face, and is embedded in the pleat tips such that the reinforcing webbing mechanically entraps the pleat tips. Preferably at least half, and more preferably almost all of the thickness of the web is embedded into the media material at the pleat tips. The thermoplastic reinforcing webbing interconnects adjacent tips and protects the pleat tips from damage and collapse during use and stabilizes the pleated filter media when under high fluid flow or high pressure-difference conditions.

A method of reinforcing a media pack is provided by forming a pleated media pack to have a panel of folds with a plurality of pleat tips and valleys. A thermoplastic is applied directly to the pleat tips and embedded therein, such that the thermoplastic mechanically entraps the pleat tips. The applied thermoplastic forms a reinforcing web structure during the process.

At least one embodiment of the invention provides that the reinforcing structure for the media pack is pre-molded as a separate thermoplastic panel. The panel is then applied to the pleated filter media pack and thermally softened, such that the reinforcing structure melts and embeds into the media at the pleat tips. When cooled, the pre-molded reinforcing structure is fixed in place, and mechanically entraps the pleat tips.

In any of the above techniques, the reinforcing structure provides lengthwise as well as widthwise support of the pleats.

In accordance with a first aspect of the present invention, a filter element is provided with a reinforcing structure that is embedded. The filter element comprises a pleated filter media comprising a folded panel having a plurality of pleat tips and valleys, with the pleated filter media having an inlet face and an outlet face. The filter element further comprises a thermoplastic reinforcing structure (e.g., one or more reinforcing structures) attached to either the inlet face, the outlet face, or both the inlet and outlet face of the pleated filter media, with the reinforcing structure embedded into and mechanically entrapping the pleat tips. The thermoplastic reinforcing structure define a webbing that interconnects adjacent tips.

In the above aspect, the webbing can protect the pleat tips from damage and collapse and stabilizes the pleated filter media when under high fluid flow or high pressure-difference conditions.

Various features may be used alone or in combination with this aspect as described below.

It is a feature that preferably at least half the thickness of the thermoplastic reinforcing structure is embedded into the pleat tips of the filter media. For example, in some embodiments most of the thickness of the thermoplastic reinforcing structure is embedded into the pleat tips of the filter media.

It is a feature that the thermoplastic reinforcing structure may be a pre-molded structure.

It is a feature that the thermoplastic reinforcing structure may be a honeycomb structure.

It is a feature that the pleated filter media may be relatively deep to define a pleat depth between the inlet face and the outlet face with for example the pleat depth being at least 4 inches. In such relatively deep pleated filter media, the filter media preferably defines a plurality of formed embossments offset from pleat tips and extending between pleat tips at the inlet face and the outlet face.

It is a feature that the thermoplastic reinforcing structure may comprise a polypropylene, a nylon, a polyoxymethylene, and/or acrylonitrile butadiene styrene.

It is a feature that the thermoplastic reinforcing structure may comprise a preform web preformed thermoplastic bars or stock coil strips, and/or a netting, and has a melted side welded to pleat tips of the filter media pack.

It is a feature that the webbing may comprise an array of interconnected web segments with a first set of web segment that extend in a different direction that a second set of web segment. At least some of the web segments may extend across pleat tips diagonally relative to the pleat tips. Flow openings communicating are defined between adjacent web segments to allow fluid flow therethrough.

The pleat tips can extend between first and second opposite ends of the pleated filter media, with a further feature being that first and second end caps are provided and bonded to the first and second opposite ends, respectively. Preferably, the thermoplastic reinforcing structure is bonded to each of the first and second end caps.

In the above feature, different options are provided for the endcaps, for example: (a) the first and second end caps may molded-in-place end caps embedded into the first and second ends with the thermoplastic reinforcing structure embedded into the molded-in-place end caps, or (b) the first and second end caps may be preformed end caps with respective adhesive layers affixed to the first and second ends, with the thermoplastic reinforcing structure embedded into the adhesive layers.

It is a feature that the thermoplastic reinforcing structure may be provided by a preform having first and second rails and web segments connected between the rails.

In the above feature it can be a further feature that the first and second rails engage with first and second outermost pleat tips, respectively.

Optionally in the above two feature(s), the rails extend over the outermost pleat panels opposed sides of the pleated filter media with the web segments extending thereacross to define an elongated U-shaped receiving channel for receipt of one of the inlet face and the outlet face.

It is a feature that the filter element may further comprise a housing border gasket extending around a periphery of the pleated filter media.

Another inventive aspect is directed toward reinforcement features of a filter element having a filter media pack comprising a first pair of opposite sides, a second pair of opposite ends, and opposed inlet and outlet flow faces, with the opposite sides extending transversely between opposite ends, and with the pair of opposite ends and the pair of opposite sides extending transversely between opposed inlet and outlet flow faces. The filter element further comprises a pair of end caps secured to opposites ends of the filter media pack in spaced relation; and a first reinforcing structure comprising at least one web segment having a portion intermediate of the end caps that is bonded to one of the inlet and outlet flow faces.

Various features may be used alone or in combination with this aspect as described either above or below.

It is a feature that the filter media pack may comprise a pleated filter media comprising a folded panel having a plurality of pleat tips and valleys.

In the above feature (a) the pleated filter media may define a pleat depth between the inlet face and the outlet face, with the pleat depth being at least 4 inches and/or (b) the filter media may define a plurality of formed embossments offset from pleat tips and extending between pleat tips at the inlet face and the outlet face.

It is a feature that the reinforcing structure may comprise a thermoplastic material that is thermal melt bonded to the one of the inlet and outlet flow faces.

It is a feature that the reinforcing structure may be a unitary component made only from a single material that is integrally bonded to the filter media pack by a melt bonded portion of the single material and without additional separate adhesive.

It is a feature that the thermoplastic reinforcing structure may comprise: a preform web, preformed thermoplastic bars or stock coil strips, and/or a netting, and has a melted side welded to pleat tips of the filter media pack.

It is a feature that the first reinforcing structure may comprise an array of interconnected web segments with a first set of web segments that extend in a different direction than a second set of web segments, and preferably at least some of the web segments extend across pleat tips diagonally relative to the pleat tips.

It is a feature that the thermoplastic reinforcing structure may further be bonded to each of the first and second end caps.

In the above aspect, different options exist for the end caps, for example: (a) the first and second end caps may be molded-in-place end caps embedded into the first and second ends with the thermoplastic reinforcing structure embedded into the molded-in-place end caps, or (b) the first and second end caps may be preformed end caps with respective adhesive layers affixed to the first and second ends, with the thermoplastic reinforcing structure embedded into the adhesive layers.

It is a feature that the reinforcing structure may be provided by a preform having first and second rails and web segments connected between the rails.

In the above feature the first and second rails extend over the opposed sides, respectively; and with the web segments extending thereacross to optionally define an elongated U-shaped receiving channel for receipt of one of the inlet face and the outlet face.

It is a feature that the filter element may comprise a housing border gasket extending around a periphery of the pleated filter media.

In the above aspect a second reinforcing structure is preferably provided comprising at least one web segment having a portion intermediate of the end caps that is bonded to a different one of the inlet and outlet flow faces than the first reinforcing structure.

Additional inventive aspects are directed toward methods that may be used to create the filter elements and may employ such features thereof as described above.

An inventive aspect is directed toward a method of reinforcing a media pack. The method comprising the steps of: (a) forming a pleated media pack to have an interconnected panel of folds with a plurality of pleat tips and valleys, the pleated media pack having an inlet face and an outlet face; and (b) applying a pre-molded thermoplastic reinforcing structure to the pleat tips and thermally softening the thermoplastic reinforcing structure such that the thermoplastic reinforcing structure embeds in and mechanically entraps the pleat tips.

In the above method, the thermoplastic reinforcing structure can interconnect adjacent tips and protects the pleat tips from damage and collapse and stabilizes the pleated filter media when under high fluid flow or high pressure-difference conditions.

Various features (including those for filter element apparatus aspects above) may be used alone or in combination with this aspect as described either above or below.

It is a feature that the method may include the step of embedding at least half the thickness of the thermoplastic reinforcing structure into the pleat tips of the media. For example, in some embodiments, the method may involve embedding most of the thickness of the thermoplastic reinforcing structure into the pleat tips of the media.

Another inventive aspect is directed toward a method of reinforcing a filter media pack for forming a filter element, in which the method comprises: (a) heating a material of a reinforcing preform providing at least one web segment to form an embed pool of the reinforcing preform; (b) applying the reinforcing preform to a flow face of the filter media pack; and (c) embedding the embed pool of the reinforcing preform into the flow face of the filter media pack.

Various features (including those for filter element apparatus aspects above) may be used alone or in combination with this aspect as described either above or below.

It is a feature that the applying may be performed after the heating, and wherein preferably only one side of the reinforcing preform is heated.

It is a feature that the applying is performed prior to the heating, and preferably weighting force is applied during said heating.

It is a feature that the method may further comprise constructing the filter media pack to comprise a first pair of opposite sides, a second pair of opposite ends, and opposed inlet and outlet flow faces, said flow face being one of the inlet and outlet faces, with the opposite sides extending transversely between opposite ends, the pair of opposite ends and the pair of opposite sides extending transversely between opposed inlet and outlet flow faces.

In the above feature, the constructing may comprise pleating and optionally embossing a filter media sheet to construct the filter media pack, to provide a pleated filter media comprising a folded panel having a plurality of pleat tips and valleys. In such a pleated filter media, the embed pool spans over multiple pleat tips whereby the web segment interconnects adjacent pleat tips

It is a feature that the reinforcing structure may comprise a thermoplastic material, and wherein said heating at least partially melts the thermoplastic material on at least one side of the reinforcing preform.

It is a feature that the method may further comprise securing end caps to opposed ends of the filter media pack.

In the above feature, the preferrable method further comprises connecting the reinforcing preform to each of the end caps (for example, preferably by embedding into adhesive material of the endcaps).

It is a feature that the reinforcing preform may have first and second rails and web segments connected between the rails, and the method may further comprise arranging rails over and/or proximate opposed sides of the filter media pack with the web segments extending across the flow face and defining flow openings between adjacent web segments.

In the above feature, the method may further comprise locating the rails along opposed sides of the filter media pack, with the web segments extending thereacross to define an elongated U-shaped receiving channel and receiving the U-shaped channel over the flow face.

Another inventive aspect is directed to a filter element with a catch feature on an end cap that may position other structure.

In an embodiment, according to this inventive aspect, a filter element comprises a filter media pack. The filter media pack may comprise a first pair of opposite sides, a second pair of opposite ends, and opposed inlet and outlet flow faces, with the opposite sides extending transversely between opposite ends, and with the pair of opposite ends and the pair of opposite sides extending transversely between opposed inlet and outlet flow faces. The filter element further comprises at least one wall member providing a catch member. The at least one wall member is attached over the filter media pack. The wall member has a central panel having an exterior face, an interior face, and a peripheral border surface extending around the central panel between the exterior face and the interior face. The exterior face faces away from the filter media pack. The catch member extends from the central panel along the central exterior face. The filter element also comprises a frame extending around the filter media pack, with the catch member positioning the frame relative to the filter media pack.

Various features (including those for filter element apparatus aspects above) may be used alone or in combination with this aspect as described either above or below.

It is a feature that the interior face of the central panel covers and seals one of the ends of the filter media pack. The filter media pack is preferably a pleated filter media pack with the interior face of central panel sealing open valleys between adjacent pleat panels of the pleated filter media pack.

It is a feature that the catch member defines an elongated ledge surface upon which the frame is seated. Preferably the elongated ledge surface extends at least 2 centimeters, and more preferably at least 5 centimeters.

It is a feature that the catch member spans at least half of a span of one of the ends of the filter media pack, and preferably all or substantially all of the span of one of the ends of the filter media pack.

It is a feature that the filter element further comprises a gasket extending around the filter media pack and supported by a seal support structure of the frame.

It is a feature that the at least one wall member comprises first and second end caps on opposite ends of the filter media pack, with the first end cap including a first catch and the second end cap including a second catch.

It is a feature that each wall member is a molded-in-place end cap having a first portion on the interior surface embedded into the end of the filter media pack, and a second portion on the exterior face providing the catch member.

In the above feature it is a further feature that the first and second portions are unitary with each other and molded together from a common material, preferably polyurethane or other foam material. The common material can a durometer of between 20 and 40 Shore D hardness or between 10 and 30 shore A hardness, but is most preferably a harder material between 25 and 35 shore D hardness.

In another embodiment, according to this inventive aspect, a filter element comprises a filter media pack. The filter media pack may comprise a first pair of opposite sides, a second pair of opposite ends, and opposed inlet and outlet flow faces, with the opposite sides extending transversely between opposite ends, and with the pair of opposite ends and the pair of opposite sides extending transversely between opposed inlet and outlet flow faces. The filter element further comprises at least one wall member providing a catch member, with the at least one wall member being a mold-in-place end cap embedded into the filter media pack. Further, the filter element comprises a frame extending around the filter media pack, with the catch member positioning the frame relative to the filter media pack.

Various features (including those for filter element apparatus aspects above) may be used alone or in combination with this aspect as described either above or below.

It is a feature that the at least one wall member comprises first and second mold-in-place end caps on opposite ends of the filter media pack, with the first end cap integrally including a first catch and the second end cap integrally including a second catch.

It is a feature that the molded-in-place end cap has a first portion on the interior surface embedded into the end of the filter media pack, and a second portion on the exterior face providing the catch member. The first and second portions can be unitary with each other and molded together from a common material, preferably polyurethane or other foam material. The common material can have a durometer of between 20 and 40 Shore D hardness or between 10 and 30 shore A hardness, and most preferably is a harder material between 25 and 35 shore D hardness.

It is a feature that the catch member defines an elongated ledge surface upon which the frame is seated. Preferably the elongated ledge surface extends at least 2 centimeters, more preferably at least 5 centimeters.

It is a feature that the catch member spans at least half of a span of one of the ends of the filter media pack, and preferably all or substantially all of the span of one of the ends of the filter media pack.

It is a feature that the filter element comprises a gasket extending around the filter media pack and supported by a seal support structure of the frame.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric outlet-side view of a filter element with a reinforcing structure that defines a webbing that interconnects adjacent tips according to an embodiment of the present invention;

FIG. 2 is an isometric inlet-side view of the filter element shown in FIG. 1;

FIG. 3 is an exploded isometric assembly view of the filter element shown in FIG. 1;

FIG. 4 is a cross section of the filter element of FIG. 1, taken along a plane parallel to the central axis between the inlet and outlet flow faces, and parallel to opposed end caps;

FIG. 4A is an enlarged fragmentary end elevation cross-section view of part of the plane of FIG. 4 to better show thermoplastic material of the reinforcing structure embedded into pleat tips at inlet/outlet faces in accordance with an embodiment;

FIG. 5 is a cross section of the filter element of FIG. 1, taken along a plane parallel to the central axis between the inlet and outlet flow faces, and perpendicular to opposed end caps (i.e., perpendicular to that of FIG. 4);

FIG. 6 is an inlet/outlet face perspective view of a filter element according to an alternative embodiment similar to the embodiment of FIG. 1, except that the reinforcing structure spans partially rather than fully between end caps;

FIG. 7 is a perspective view of the filter element shown in FIG. 6.

FIG. 8, is an isometric view a filter element that is the same as FIG. 1, except for a different configuration pattern of reinforcing structure that defines a webbing that interconnects adjacent tips, and slightly differently configured end caps and seal support frame assembly components, according to an alternative embodiment of the present invention;

FIG. 9, is an isometric view a filter element that is the same as FIG. 1, except for a different configuration pattern of reinforcing structure that defines a webbing that interconnects adjacent tips, and slightly differently configured end caps and seal support frame assembly components, according to a further alternative embodiment of the present invention;

FIG. 10, is an isometric view a filter element that is the same as FIG. 1, except for a different configuration pattern of reinforcing structure that defines a webbing that interconnects adjacent tips, and slightly differently configured end caps and seal support frame assembly components, according to a further alternative embodiment of the present invention;

FIG. 11 is an isometric view of a portion of a pleated filter media pack used/usable in any of the embodiments of FIGS. 1-10; and

FIG. 12 is an isometric view of four pleat panels of the pleated filter media pack used/usable in any of the embodiments of FIGS. 1-10.

FIG. 13 is a flow face plan view of the reinforcing structure shown as a grate used in the embodiment of FIG. 1-5;

FIG. 14 is an isometric end view of the reinforcing structure shown in FIG. 13, with dashed lines showing optionally how the rails may project from central webbing/cross-member along opposed sides for location features of a U-shaped channel configuration;

FIG. 15 is an isometric view of a filter element according to yet a further illustrated embodiment featuring a novel catch feature in accordance with a further inventive aspect;

FIG. 16 is an exploded assembly view of the filter element shown in FIG. 15;

FIG. 17 is a cross section of the filter element shown in FIG. 15;

FIG. 18 is an enlarged view of a left-hand portion of that cross-section illustrated FIG. 17;

FIG. 19 is an isometric view of the exterior face of the mold-in-place end cap component of the filter element of FIG. 15; and

FIG. 20 is an isometric view of the interior face of the mold-in-place end cap component of the filter element of FIG. 19.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

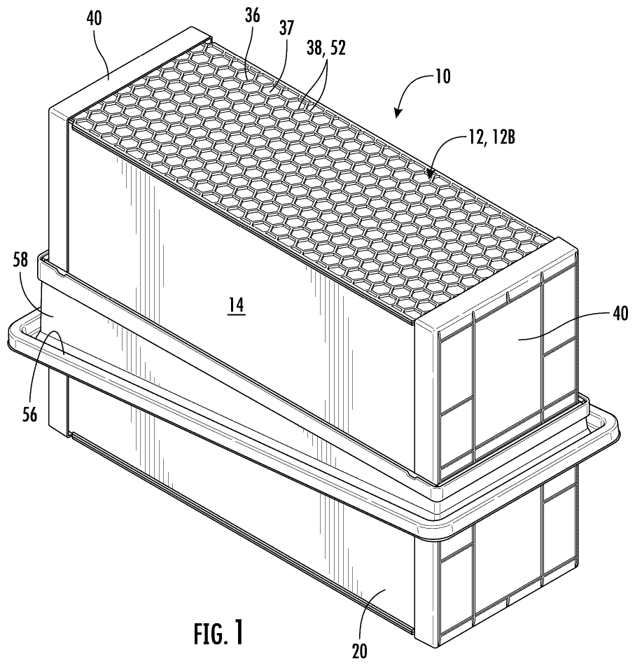

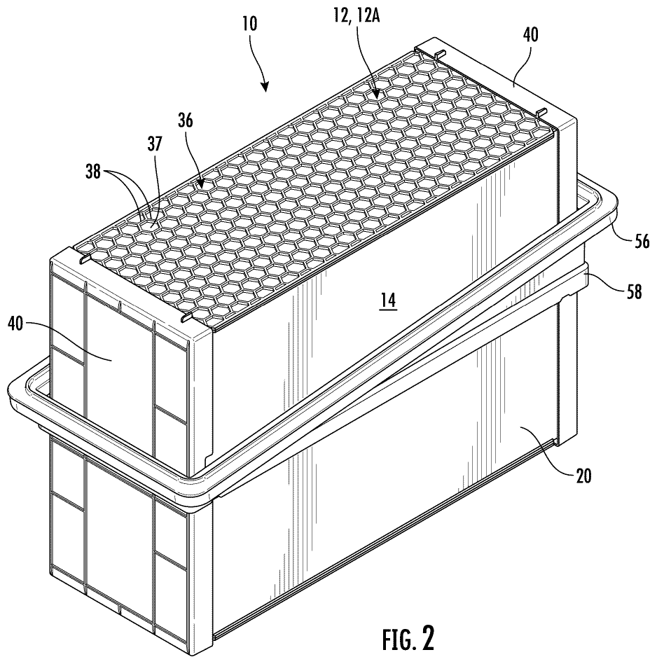

FIGS. 1-5 illustrate a filter element 10 having a reinforcing structure 12 embedded into a filter media pack 14 of the filter element according to a first illustrated embodiment of the present invention.

The filter media pack 14 has opposite flow faces including an inlet face 16 and an outlet face 18. Unfiltered fluid flow can enter the inlet face 16 and pass through filter media 20 of the filter media pack 14 and leave the outlet flow face 18 cleaner. For example, particulates or contaminants in the unfiltered fluid flow can be trapped with the material of the filter media 20 (e.g., a filter media sheet).

The filter media pack 14 may take the form of a cuboid, which as shown includes a first pair of opposite sides 22, 23, and a second pair of opposite ends 24, 25. The opposite sides 22, 23 extend transversely between opposite ends 24, 25; and the pair of opposite ends 22, 23 and the pair of opposite sides 24, 25 extend transversely between opposed inlet and outlet flow faces 16, 18. For example, the filter media pack 14 may be rectangular and with right angles such that opposite sides 22, 23 extend perpendicularly between opposite ends 24, 25; and the pair of opposite ends 24, 25 and the pair of opposite sides 22, 23 extend perpendicularly between opposed inlet and outlet flow faces 16, 18.

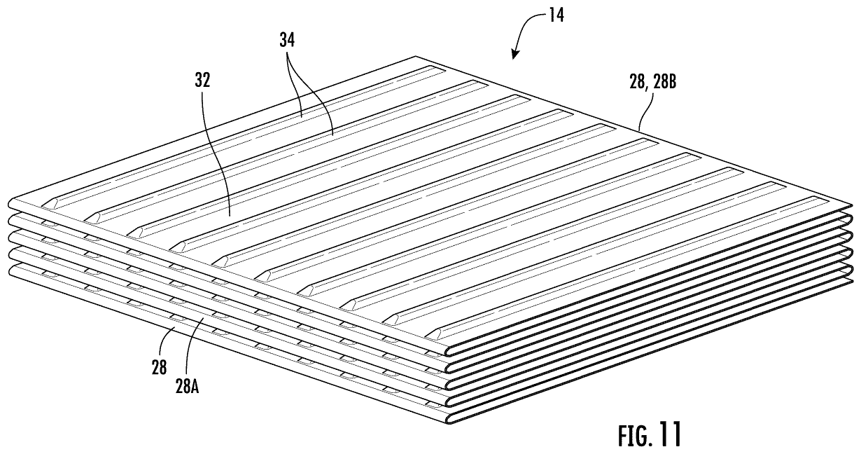

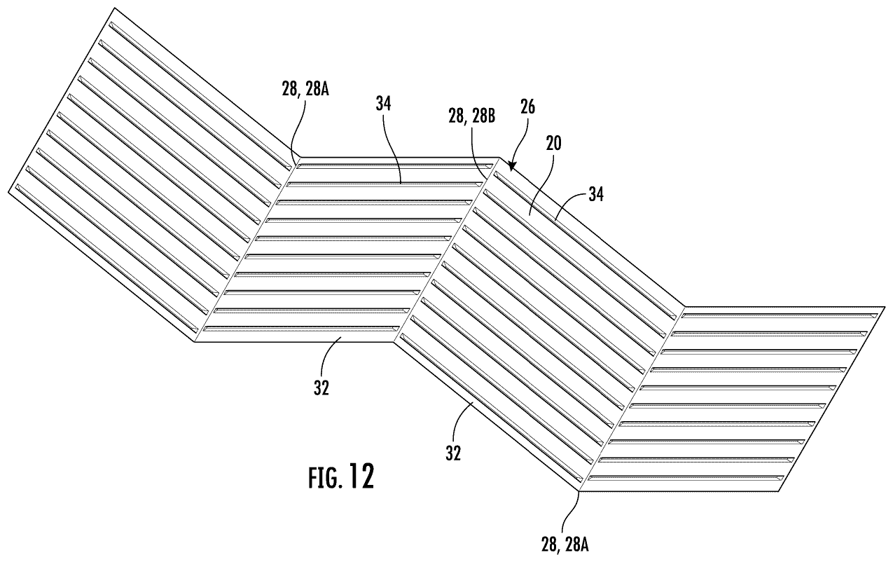

Although the filter media pack 14 may be constructed in alternative forms such as fluted filter media packs with adhesively sealed alternative cut sheets in additional embodiments of the present invention, embodiments herein are most useful to solving issues of pleated type and especially deeper pleat packs (e.g., pleat pack having a pleat depth of at least 4 inches, and more typically a pleat depth of between 6 and 20 inches), with additional details shown in FIGS. 11-12, and that may be described further with additional filter media options in PCT Application No. PCT/US24/44109 entitled Variable Height, Offset, Angled & Bridge Embossments, which is hereby incorporated by reference in its entirety for further filter media details that may be employed in embodiments herein.

Thus, the filter media pack 14 is shown a pleated filter media pack. As applied to pleated filter media packs, the reinforcing structure not only protects the pleat tips from damage but can also help prevent collapse and stabilizes the pleated filter media when under high fluid flow or high pressure-difference conditions. This may prevent blinding off of media and/or organize fluid flow better to keep pressure differentials lower for better fluid flow conditions.

As in the case of the pleated example of the illustrated embodiment, the filter media pack 14 comprises a folded panel in the form a pleated filter media sheet 26 having a plurality of pleat tips 28 and valleys 30 between adjacent pleat tips 28. Pleat tips 28 are at the inlet face and the outlet face (thus inlet pleat tips providing the inlet face 16 and outlet pleat tips providing the outlet face 18), with individual pleat panels 32 extending therebetween and adjacent panels 32 connected by pleat tips 28.

In the case of the pleated filter media pack, the reinforcing structure 12 not only protects pleat tips 28, but also helps maintain spacing between the pleat panels 32 to ensure fluid such as air flow can easily flow into valleys 30 between adjacent pleat panels 32 along the inlet side and exit from along valleys 30 between adjacent pleat panels 32 along the outlet side. Also, optionally and preferably especially in deeper pleat packs, the filter media defines a plurality of formed embossments 34 (see e.g., FIGS. 11-12) such as elongated channels that may be offset from pleat tips 28 and extending between pleat tips 28 at the inlet and outlet faces 16, 18.

The reinforcing structure 12 can be bonded and pressed into either the inlet face 16, the outlet face 18, or more preferably as shown both of the inlet and outlet faces 16, 18 as shown to provide even more support and protection in which two separate reinforcing structures 12A (at the inlet face 16) and 12B (at the outlet face) are provided. Broader claims appended hereto encompass all such situations where one reinforcing structure is provided and where two reinforcing structures are provided.

The reinforcing structure 12 comprises a webbing 36 at least one web segment 38, and for example, typically multiple interconnected web segments 38. At least one web segment 38 provides a portion that is bonded to one of the inlet and outlet flow faces 16, 18; for example, in a region intermediate of opposed ends 24, 25 and intermediate of opposed end caps 40 that may be secured to opposed ends 24, 25 in spaced relation.

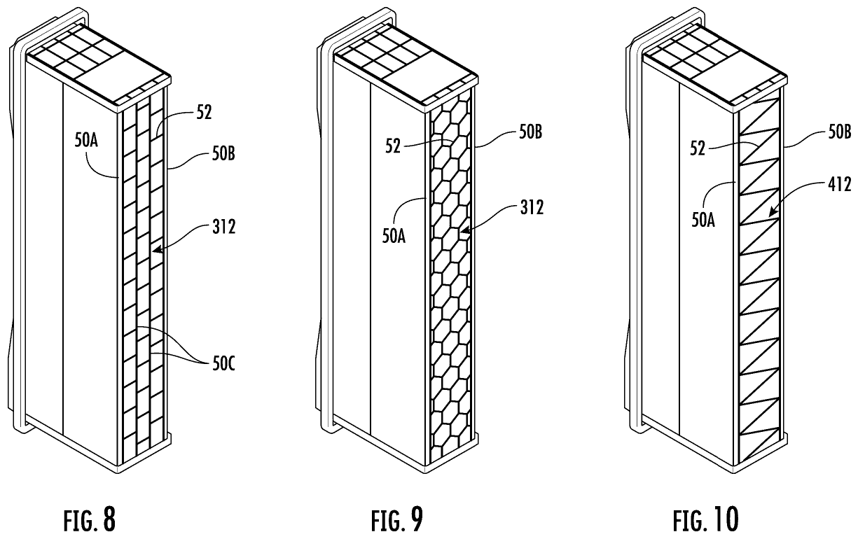

Different options existing for such reinforcing structure 12 configuration such as shown in FIGS. 1-5 and with additional comparison to FIGS. 8-10. For example, the embodiments as illustrated in FIGS. 1-10 preferably show the reinforcing structure as a grating such as a framework with cross members. As illustrated and in general, the thermoplastic reinforcing structure 12 can comprise a preform web, preformed thermoplastic bars or stock coil strips that may be connected in place, and/or a netting; and in these cases, typically has a melted side welded to pleat tips of the filter media pack. Preferably, the thermoplastic reinforcing structure 12 is a pre-molded structure molded from thermoplastic material, and with the material being thermoplastic it can be partially or fully remelted to embed into pleat tips 28. The thermoplastic reinforcing structure may have a honeycomb structure according to some embodiments. Further discussion is not needed as it is understood that the disclosure and discussion of the prior embodiments of FIGS. 1-5 is applicable to that of FIGS. 8-10 and vice versa.

In an embodiment such as the illustrated embodiment of FIGS. 1-5, the reinforcing structure 12 comprises a thermoplastic material that is integrally bonded to pleat tips 28 at one of the flow faces, providing a thermoplastic reinforcing structure attached to either the inlet face, the outlet face, or both the inlet and outlet face of the pleated filter media (e.g., FIGS. 1-5 show a first and second reinforcing structure 12A and 12B connected separately to the inlet and outlet flow faces 16, 18 or vice versa). The thermoplastic material of the reinforcing structure 12 is embedded into and mechanically entraps the pleat tips 28 at the flow face to which it is attached; and with the reinforcing structure 12 defines webbing 36 that interconnects adjacent tips 28 while allowing fluid flow to pass through the webbing along openings 37 defined through the webbing 36.

Examples of suitable thermoplastic materials that are incorporated into the thermoplastic reinforcing structure 12 include but are not limited to a polypropylene, a nylon, a polyoxymethylene, and/or acrylonitrile butadiene styrene (ABS). Fillers, glass fibers or other reinforcing fibers may also be integrated into such thermoplastic material for additional strength and rigidity.

In the illustrated pleated filter media embodiment example of FIGS. 1-5, the pleat tips 28 extend between the first and second opposite ends 24, 25 of the pleated filter media, with first and second end caps 40 bonded to the first and second opposite ends 24, 25, respectively. In such example, the thermoplastic reinforcing structure 12 can further be bonded to each of the first and second end caps 40 interconnecting components and providing even further support.

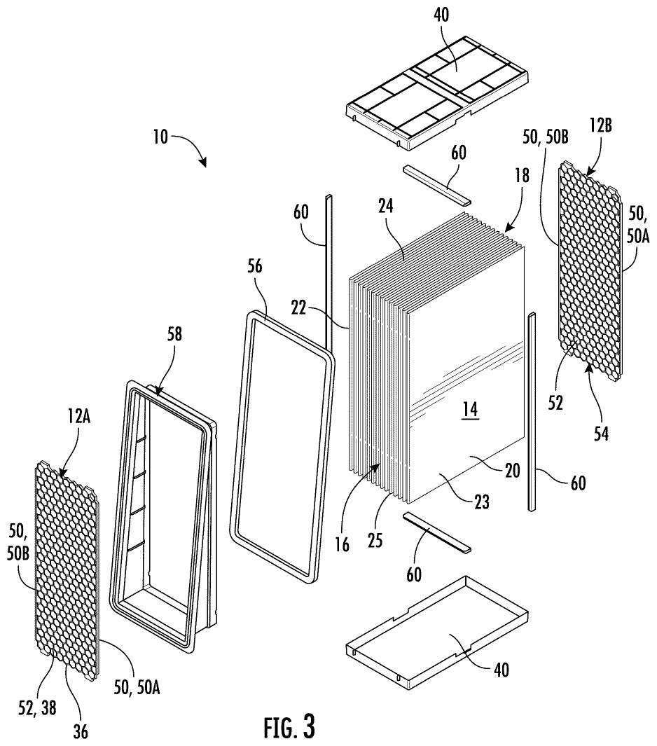

Different possibilities exist for the end caps 40. For example, in the illustrated pleated filter media embodiment example of FIGS. 1-5, the end caps 40 are preformed end caps 42 (e.g., molded end cap preforms) with respective adhesive layers 44 affixed to the first and second ends 24, 25, with the thermoplastic reinforcing structure 12 embedded into the adhesive layers 44 (in addition to bonded and preferably embedded into pleat tips 28). Alternatively, the first and second end caps 40 shown such as in FIG. 3 may be molded-in-place end caps (e.g., formed of urethane, plastisol or other potting compound formed in place with a reusable mold) embedded directly into the first and second ends 24, 25 with the thermoplastic reinforcing structure 12 embedded into the urethane or other such potting material of such molded-in-place end caps.

In either case, the end caps 40 sealingly engage and close the otherwise open valleys 30 of the pleated filter media sheet 26 at opposite ends 24, 25.

The reinforcing structure 12 is pressed into one of the flow faces sufficiently to bond and set the pleats and this is most advantageous if most (i.e., at least half the thickness) of the thermoplastic reinforcing structure 12 is embedded into the pleat tips 28 of the filter media 20.

For example, as discussed above, the reinforcing structure 12 comprises a thermoplastic material that is thermal melt bonded (may also be referred to as “welded”) to the one of the inlet and outlet flow faces. Most preferably, the reinforcing structure is a unitary component made only from a single material that is integrally bonded to the filter media pack by a melt bonded portion of the single material and without additional separate adhesive.

For example, to provide desired support while limiting bulkiness, the thermoplastic reinforcing structure 12 may have a cross-member thickness 46 (axial depth, e.g., at the region to be placed over the pleat tips and measured in unembedded state) preferably of at least 2 millimeters, and preferably less than 6 millimeters (for example, a reinforcing structure thickness of 4 millimeters). Then, the embed depth 148 may be between anywhere from 30% to 95% of the thickness 46, and more preferably 65% to 95% of the thickness 46 (for example, for a 4 millimeter thick reinforcing structure 12, a target embed depth of 2 millimeters).

The web segments 38 may take various forms, and as illustrated may include one or more rail(s) 50 and one or more cross member(s) 52, as shown in the various embodiment of reinforcing structures 12, 112, 212, 312, 412.

For example, as shown in FIG. 1 (and also shown in FIGS. 8-10 embodiments, the thermoplastic reinforcing structure 12, 212, 312, 412 is provided by a preform having at least first and second outer rails 50A and 50B, and web segments such as cross members 52 connected between the rails 50A and 50B. Optionally as shown in FIG. 8, additional intermediate rails 50 C may be employed.

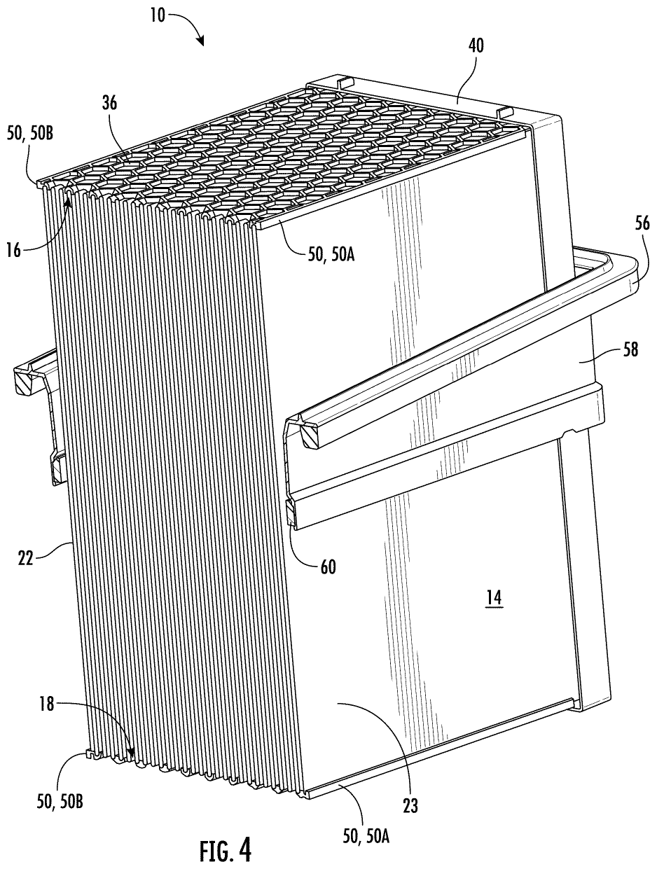

The first and second outer rails 50A, 50B engage with first and second outermost pleat tips 28A, 28B, respectively, as best shown in FIG. 4. This provide a larger span on support and protection.

Even more preferably as shown in FIG. 4, the outer rails 50A, 50B extend over the outermost pleat panels 32 (of pleat tips 28A, 28B; and see pleat panels shown better in FIGS. 11-12, with four pleat panels shown in FIG. 12). The rails 50A, 50B may thus be arranged on distal opposed sides of the pleated filter media sheet 26 with the web segment cross members 52 extending thereacross to optionally define an elongated U-shaped receiving channel 54 for receipt of one of the inlet face and the outlet face. If used, a U-shaped receiving channel 54 which is relatively rigid compared to a more flexible/expandable pleated filter media sheet 126 can also thereby be used to set the pleat pack width span.

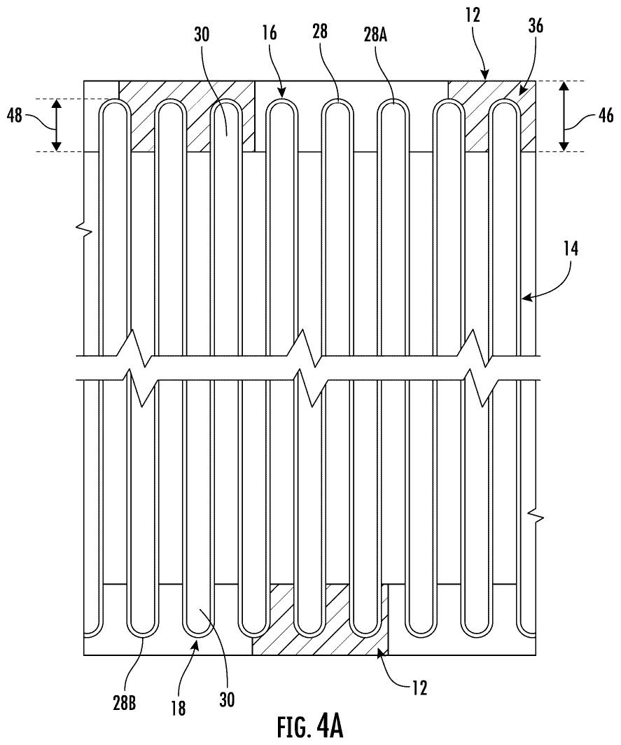

The reinforcing structure 12 may also be assembled and preferable thermally bonded through thermoplastic melt pool bonding (e.g., as shown best in FIG. 5), prior to application of end caps 40, and other such optional external components such as for example a housing border gasket 56 that defines a ring extending around a periphery of the pleated filter media pack 14. Housing border gasket 56 is shown herein connected to the filter media pack 14 via a surrounding border frame 58 that can be bonded to the filter media pack 14 and the end caps 40 via a ring of adhesive 60; although housing border gasket 56 may also be molded-in-place directly to the filter media pack 14 and the end caps 40.

Embodiments herein are also directed toward methods, which can be best seen in connection with FIG. 3, with additional reference to FIGS. 4-5. A method of reinforcing a media pack 14 for forming a filter element contemplates: (a) heating a material of a reinforcing structure 12 that can be preexisting as a reinforcing preform, which provides at least one web segment 38 to form a fluidized embed pool of the reinforcing preform; (b) applying the reinforcing preform to a flow face of the filter media pack; and (c) embedding the embed pool of the reinforcing preform into the flow face of the filter media pack 32.

In accomplishing this methodology, one may apply the reinforcing preform after the heating (e.g. via a radiant heat or passing through an oven). Such as using pressing force provided by a weight or press device. In such process, preferably only one side of the reinforcing preform is heated such that the melted and fluidized embed pool exists only on one side of the preform. This allows the other side to keep some rigidity during pressing and avoids sticking to such weighting or pressing device.

Another option is the reinforcing preform is applied prior to the heating, and once applied then heated such as through an oven or ultrasonic application. Preferably weighting force is applied during said heating to allow it to gradually embed as shown in the resulting FIGS. 4-5.

To complete a filter element, the method can comprise securing end caps 40 to opposed ends of the filter media pack 14. While this can be done before application of the reinforcing structure 12, more preferably it is after so as to use the bonding agent of the end caps 40 to also trap opposed ends of the reinforcing structure 12 and bond thereto. By this or otherwise, this connects the reinforcing preform to each of the end caps 40 and thereby provides for addition robust structural support.

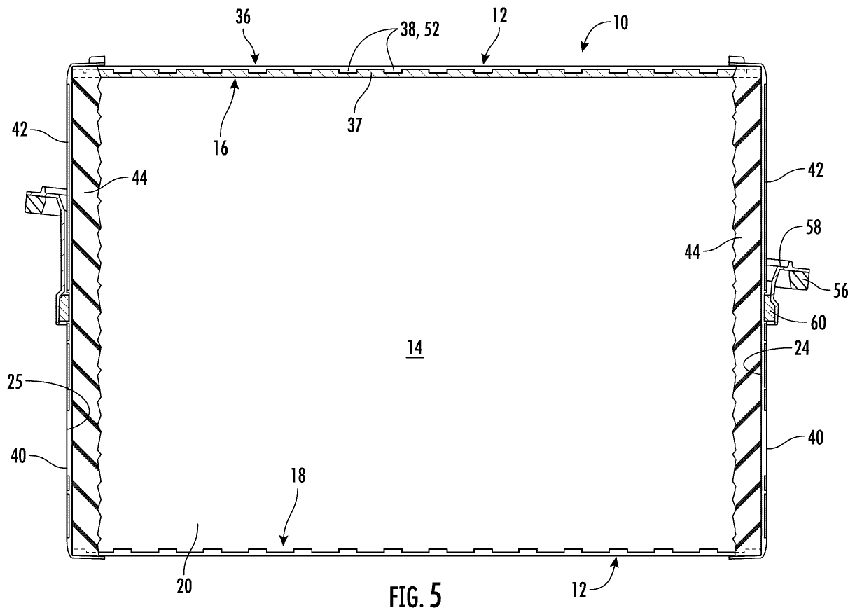

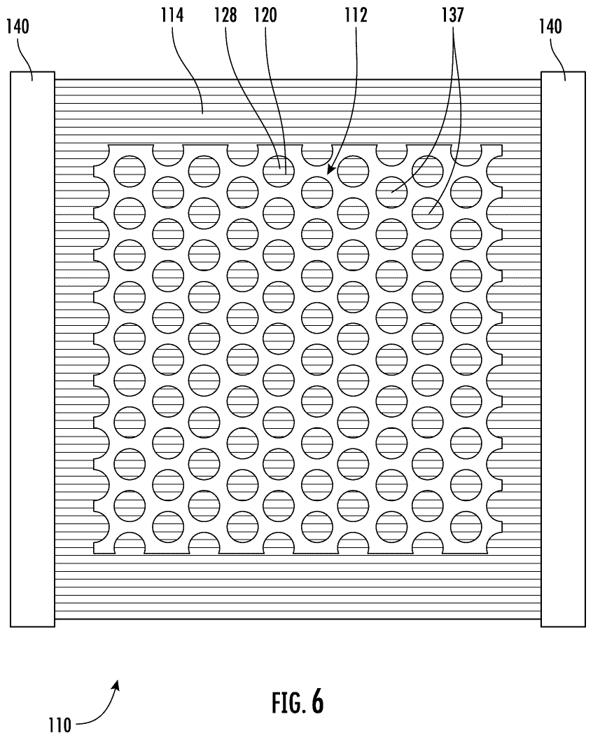

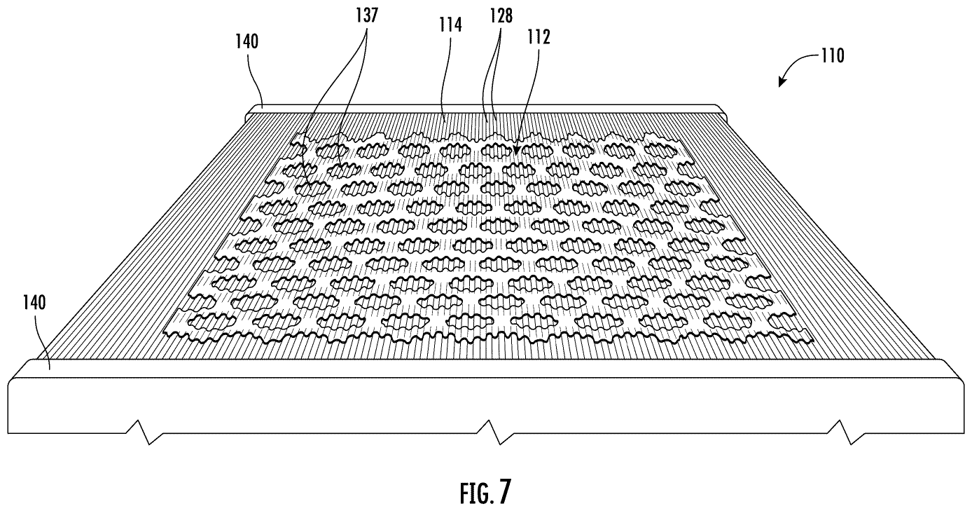

Another embodiment of a filter element 110 is shown in FIGS. 6-7 where the filter element 110 also includes a pleated media pack 114 mounted within a frame structure 140. The disclosure and discussion of the prior embodiments of FIGS. 1-5 is applicable thereto and vice versa. The media pack 114 can be sealed within the frame structure 140 with, for example, a sealant to prevent fluid bypass between the media pack and the frame structure. The frame structure 140 can take many forms and can be made of various type of materials as should be known to those skilled in the art.

The media pack 114 can be a single sheet of media that is folded to form a continuous panel that has a plurality of adjacent tips and valleys. When in use, the fluid flows into the filter from the inlet face, pass through the media pack, and exits from the outlet face. There are alternative tips and valleys on both the inlet and outlet face, with the tips on the inlet face forming the valleys of the outlet face.

As is shown in FIG. 6-7, a reinforcing structure 112 is embedded into one side of the pleated media pack. The reinforcing structure 112 can be embedded on either the inlet face or the outlet face, or on both faces of the media pack. The reinforcing structure is preferably a thermoplastic material applied in a web pattern, such as a continuous honeycomb-like pattern with adjacent openings 137 of similar geometry and size. The openings 137 within the honeycomb structure allow fluid to enter the inlet face of the filter element without substantial pressure drop or interference, pass through the media pack, and exit from the outlet face.

Referring now to FIG. 7 where a close-up of the pleat tips with the embedded thermoplastic is shown, it can be more readily seen that adjacent pleated tips 128 are connected by the thermoplastic along a face of the media pack. The reinforcing structure bridges the tips together, which provides rigidity and structural support to the pleats. The thermoplastic reinforcing structure can both protect the pleat tips from damage and can stabilize the pleat tips from collapse and deformation under high flow or high differential pressure conditions.

The thermoplastic reinforcing structure is preferably directly embedded into the media pack. In this approach, melted thermoplastic can be, for example, extruded from the nozzle of an extruder, and directly applied to the pleated tips of a media pack in a web. The reinforcing web is embedded significantly into the media at the pleat tips, for example, an embed depth of at least half the thickness of the reinforcing structure 12 may be targeted. With such embedding of the reinforcing structure, the web does not significantly increase the outer dimension of the pleat pack, so that the pleat depth can be maximized for particulate separation. The web pattern of the reinforcing structure is formed while the nozzle moves along the media pack during the embedding process.

The reinforcing structure can also be embedded by using a pre-molded thermoplastic panel having a web, for example, a honeycomb structure. With this method, a pre-molded thermoplastic panel is applied to the pleated tips of the media pack; then the thermoplastic panel is thermally softened so that the softened thermoplastic conforms around the pleated tips and embeds into the media. Again, at least half the thickness of the web, and preferably almost all of the thickness of the web is embedded into the media at the pleat tips. When cooled, the thermoplastic hardens in and around the pleated tips, which mechanically entraps the pleated tips.

The thermoplastic reinforcing structure can be a single unitary web or mesh structure as illustrated in FIG. 6. It can alternatively be a series of distinct, separated webs or meshes applied across the pleat tips. The webbing can extend the entire distance across the media face from end panel to end panel or only a portion of the distance. The webbing can also have openings of different sizes or shapes across the web and can have other patterns other than the presented honeycomb structure, such as a hex, square or triangular mesh pattern, as illustrated in FIGS. 8-10 (and FIGS. 1-5).

Both the direct and pre-molded methods use the thermoplastic material as the reinforcing structure. The reinforcing structure locks the pleat tips into place with the thermoplastic material and does not require other forms of adhesives for reinforcement, such as glue beads or resin. The webbing provides structural reinforcement to the pleats along both the length and width of the panel.

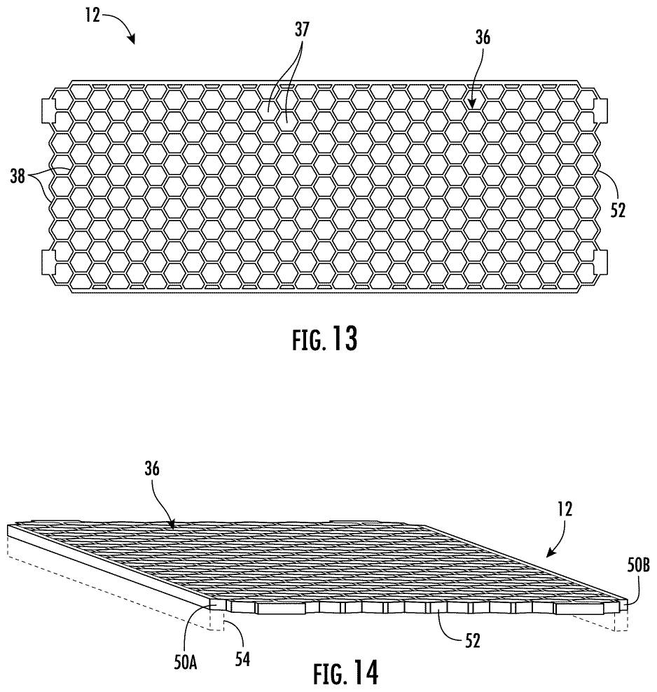

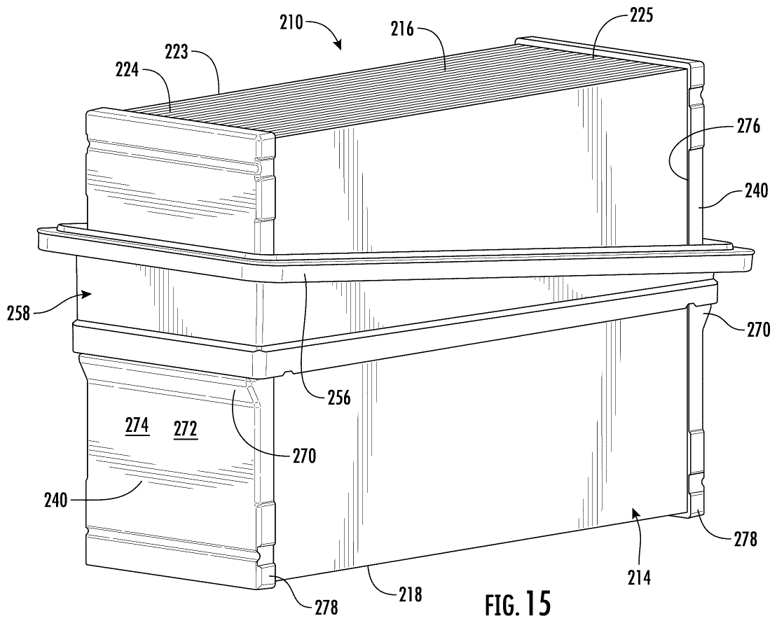

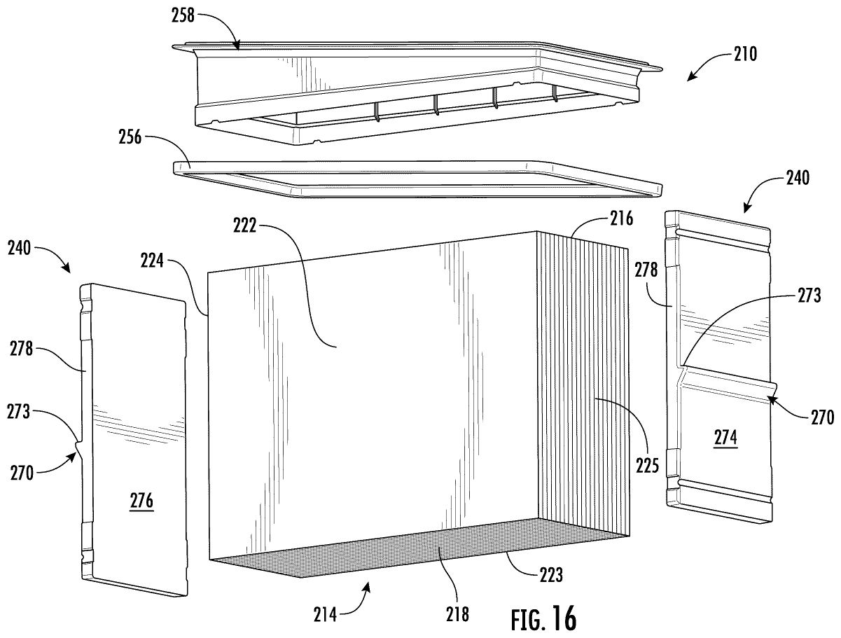

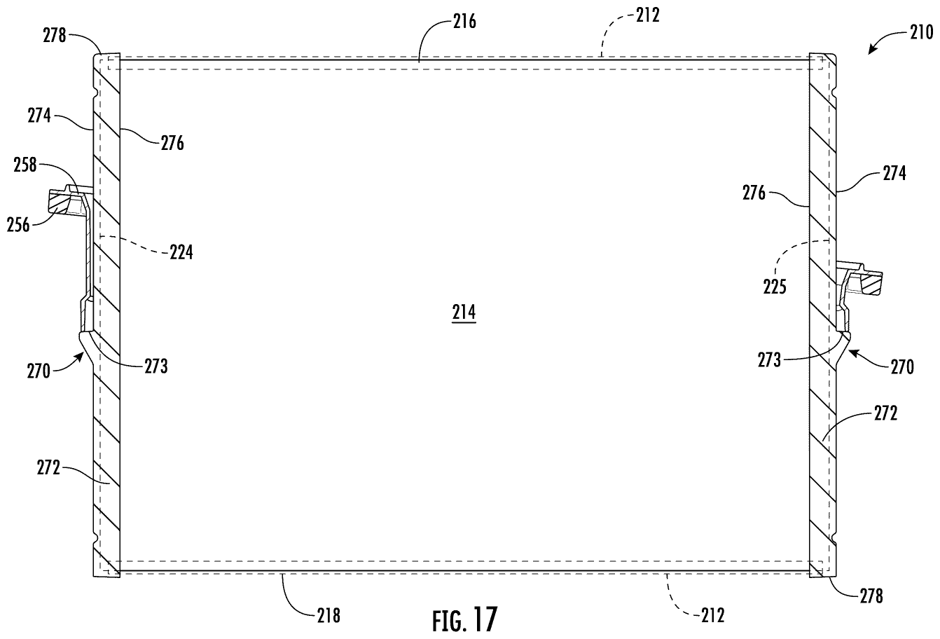

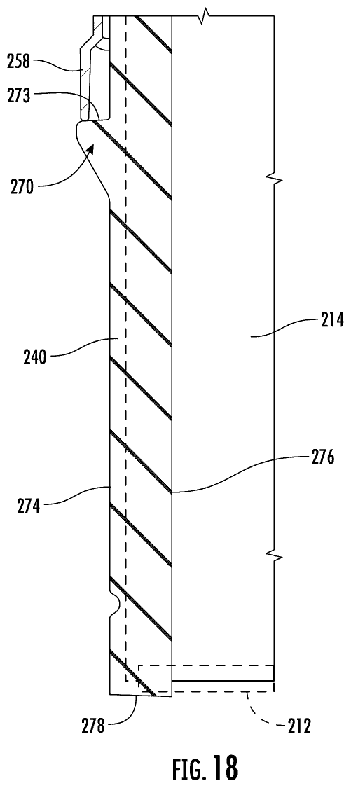

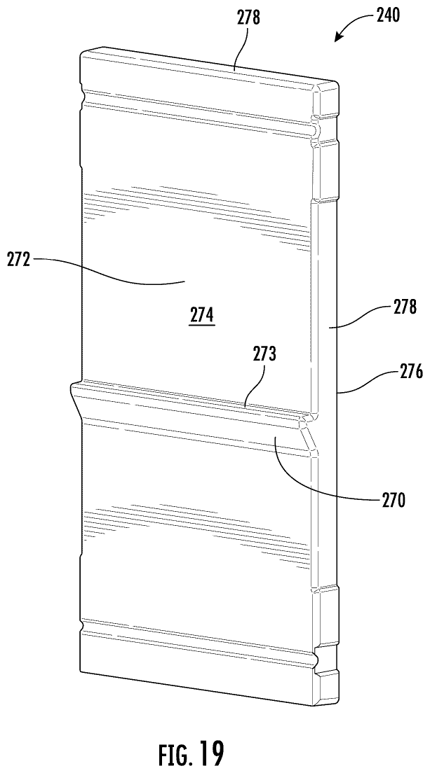

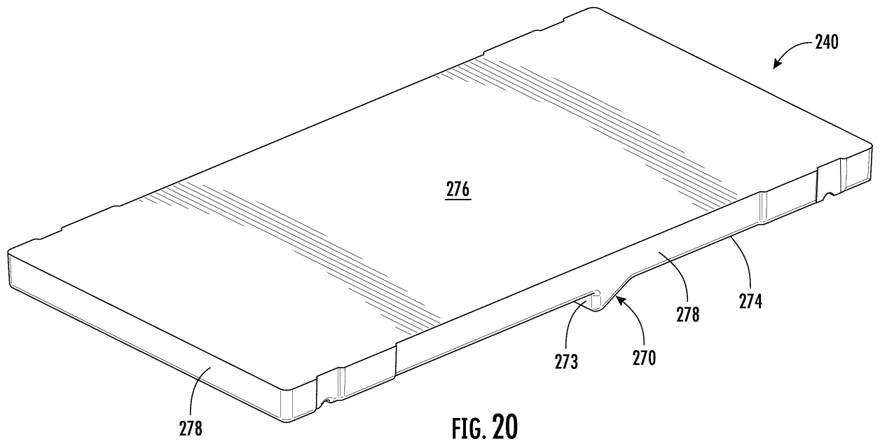

Another embodiment of a filter element 210 is shown in FIGS. 15-20 where the filter element 210 also includes a filter media pack that is preferably a pleated media pack 214 as shown. Other than as discussed below as to differences, this embodiment shares common features of the prior embodiments, as such, the disclosure and discussion of the prior embodiments of FIGS. 1-14 is applicable to this filter element 210 of FIGS. 15-20 and vice versa.

For example, this embodiment optionally may have the same reinforcing structure(s) 212 at inlet/outlet faces 216, 218 as in the prior embodiments as shown here optionally in FIG. 18 in dashed lines. However, in this embodiment the reinforcing structure 212 is embedded into mold-in-place end caps 240 at opposite ends of the filter media pack 214. The one or more reinforcing structures 212 may also be thermoplastic with melted portions embedded into the inlet and/or outlet faces 216, 218 like earlier embodiments. The mold-in-place end caps 240 can seal the otherwise open valleys 30 (see FIG. 4A) between adjacent pleat panels extending between tips 28 (FIG. 4A) at opposite ends 224, 225 and between sides 222, 223.

Thie embodiment provides additional different inventive aspects. In particular, this embodiment provides at least one wall member providing a catch member 270 that can be over the exterior face of the central panel 272. This embodiment provides the wall member in the form of the mold-in-place end cap 240 which can integrally provide a catch member 270.

The central panel 272 of the end cap 240 has an exterior face 274 which provides the catch member 270, an interior face 276 opposite of the exterior face 274, and a peripheral rectangular border surface 278. The border surface 278 extends around a periphery the central panel 272 and transversely (e.g., perpendicularly) between the exterior face 274 and the interior face 276. In the case of the mold-in-place end cap 240, the interior face 276 is embedded into one of the ends 224, 225 of the filter media pack 214 to seal the end thereof (e.g., to seal closed the otherwise open pleat valleys 30 (FIG. 4A).

Rather than extending from the peripheral rectangular border surface 278, the catch member 270 extends from the central panel 272 along the central exterior face 274 and as such can have substantial mass and provide a more substantial beam with a support ledges surface 273 upon which the frame 258 having gasket 256 can rest and be positioned, for example to properly position the gasket 256 relative to inlet/outlet flow faces 216, 218.

The catch member 270 spans at least half of a span of the ends of the filter media pack, and preferably all or substantially all (at least 85%) of the span (span being parallel to the inlet/outlet flow faces 216, 218) of the ends 224, 225 of the filter media pack 214. For example, the catch member 270 at its elongated ledge surface 273 extending at least 2 centimeters, more preferably at least 5 centimeters, and which may be a length of span between 10 and 20 centimeters.

With substantially more body due to the more extensive span, not only can the catch member 270 provide more robust support, but additionally, it may also be less rigid material provided such as by formed-in-place material, and for example polyurethane, which can be used to mold-in-place the end caps 240 rather than using pre-formed end caps potted with separate adhesive as in the earlier illustrated embodiments.

Typically, the mold-in-place end caps 240 will be of a harder material than the gasket 256 such as a more rigid/more dense polyurethane material whereas the gasket can be relatively softer, for example of a less/dense foam polyurethan material.

In an embodiment, as shown, each molded-in-place end cap 240 can have a first portion on the interior surface 276 embedded into the end of the filter media pack 214, and a second portion on the exterior surface 274 providing the catch member 270. These portions can be provided by a common pool of polymeric material during molding such that the first and second portions are unitary with each other and molded together from a common material, preferably polyurethane material. These first and second portions are unitary with each other and molded together from a common material, preferably polyurethane or other foamed material. Depending upon whether a relative softer or hard material is chosen, the material can have a relatively soft or hard composition. For example, if the same material is as the housing seal material is chosen and/or co-molded with the housing seal it may be a softer composition with durometer of between 10 and 30 Shore A hardness, and more preferably between 15 and 20 shore A hardness. However, more preferably a different harder material is chosen to provide additional support and rigidity to the filter element, having durometer of between 20 and 40 Shore D hardness, and more preferably between 25 and 35 shore D hardness.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter element, comprising:
a pleated filter media comprising a folded panel having a plurality of pleat tips and valleys, the pleated filter media having an inlet face and an outlet face; and
a thermoplastic reinforcing structure attached to either the inlet face, the outlet face, or both the inlet and outlet faces of the pleated filter media, with the reinforcing structure embedded into and mechanically entrapping the pleat tips;
wherein the thermoplastic reinforcing structure defines a webbing that interconnects adjacent tips and protects the pleat tips from damage and collapse and stabilizes the pleated filter media when under high fluid flow or high pressure-difference conditions.

2. The filter element of claim 1, wherein at least half the thickness of the thermoplastic reinforcing structure is embedded into the pleat tips of the filter media.

3. The filter element of claim 1, wherein most of the thickness of the thermoplastic reinforcing structure is embedded into the pleat tips of the filter media.

4. The filter element of claim 1, wherein the thermoplastic reinforcing structure is a pre-molded structure.

5. The filter element of claim 1, wherein the thermoplastic reinforcing structure has a honeycomb structure.

6. The filter element of claim 1, wherein the pleated filter media defines a pleat depth between the inlet face and the outlet face, wherein the pleat depth is at least 4 inches, and wherein the filter media defines a plurality of formed embossments offset from pleat tips and extending between pleat tips at the inlet face and the outlet face.

7. The filter element of claim 1, wherein the thermoplastic reinforcing structure comprises a polypropylene, a nylon, a polyoxymethylene, and/or acrylonitrile butadiene styrene.

8. The filter element of claim 1, wherein the thermoplastic reinforcing structure comprises a preform web, preformed thermoplastic bars or stock coil strips, and/or a netting, and has a melted side welded to pleat tips of the filter media pack.

9. The filter element of claim 1, wherein the webbing comprises an array of interconnected web segments with a first set of web segments that extend in a different direction than a second set of web segments, and wherein at least some of the web segments extend across pleat tips diagonally relative to the pleat tips, wherein flow openings are defined between adjacent web segments to allow fluid flow therethrough.

10. The filter element of claim 1, wherein the pleat tips extend between first and second opposite ends of the pleated filter media, and further comprising first and second end caps bonded to the first and second opposite ends, respectively; and wherein the thermoplastic reinforcing structure is bonded to each of the first and second end caps.

11. The filter element of claim 10, wherein (a) the first and second end caps are molded-in-place end caps embedded into the first and second ends with the thermoplastic reinforcing structure embedded into the molded-in-place end caps, or (b) the first and second end caps are preformed end caps with respective adhesive layers affixed to the first and second ends, with the thermoplastic reinforcing structure embedded into the adhesive layers.

12. The filter element of claim 1, wherein the thermoplastic reinforcing structure is provided by a preform having first and second rails and web segments connected between the rails.

13. The filter element of claim 12, wherein the first and second rails engage with first and second outermost pleat tips, respectively.

14. The filter element of claim 12 wherein the rails extend over the outermost pleat panels of opposed sides of the pleated filter media with the web segments extending thereacross to define an elongated U-shaped receiving channel for receipt of one of the inlet face and the outlet face.

15. The filter element of claim 1, further comprising a housing border gasket extending around a periphery of the pleated filter media.

16. A filter element, comprising:
a filter media pack comprising a first pair of opposite sides, a second pair of opposite ends, and opposed inlet and outlet flow faces, the opposite sides extending transversely between opposite ends, the pair of opposite ends and the pair of opposite sides extending transversely between opposed inlet and outlet flow faces;
a pair of end caps secured to opposite ends of the filter media pack in spaced relation; and
a first reinforcing structure comprising at least one web segment having a portion intermediate of the end caps that is bonded to one of the inlet and outlet flow faces.

17. The filter element of claim 16, wherein the filter media pack comprises a pleated filter media comprising a folded panel having a plurality of pleat tips and valleys.

18. The filter element of claim 17, wherein (a) the pleated filter media defines a pleat depth between the inlet face and the outlet face, with the pleat depth being at least 4 inches and/or (b) the filter media defines a plurality of formed embossments offset from pleat tips and extending between pleat tips at the inlet face and the outlet face.

19. The filter element of claim 16, wherein the first reinforcing structure comprises a thermoplastic material that is thermal melt bonded to the one of the inlet and outlet flow faces.

20. The filter element of claim 16, wherein the first reinforcing structure is a unitary component made only from a single material that is integrally bonded to the filter media pack by a melt bonded portion of the single material and without additional separate adhesive.

21. The filter element of claim 16, wherein the first reinforcing structure comprises: a preform web, preformed thermoplastic bars or stock coil strips, and/or a netting, and has a melted side welded to pleat tips of the filter media pack.

22. The filter element of claim 16, wherein the first reinforcing structure comprises an array of interconnected web segments with a first set of web segments that extend in a different direction than a second set of web segments, and wherein at least some of the web segments extend across pleat tips diagonally relative to the pleat tips.

23. The filter element of claim 16, wherein the first reinforcing structure is bonded to each of the first and second end caps.

24. The filter element of claim 23, wherein (a) the first and second end caps are molded-in-place end caps embedded into the first and second ends with the first reinforcing structure embedded into the molded-in-place end caps, or (b) the first and second end caps are preformed end caps with respective adhesive layers affixed to the first and second ends, with the first reinforcing structure embedded into the adhesive layers.

25. The filter element of claim 16, wherein the first reinforcing structure is provided by a preform having first and second rails and web segments connected between the rails.

26. The filter element of claim 25, wherein the first and second rails extend over the opposed sides, respectively, with the web segments extending thereacross to define an elongated U-shaped receiving channel for receipt of one of the inlet face and the outlet face.

27. The filter element of claim 16, further comprising a housing border gasket extending around a periphery of the filter media pack.

28. The filter element of claim 16, wherein a second reinforcing structure is provided comprising at least one web segment having a portion intermediate of the end caps that is bonded to a different one of the inlet and outlet flow faces than the first reinforcing structure.
